(19) United States
(12) Patent Application Publication
(10) Pub. No.: US 2012/0089444 A1
(43) Pub. Date: Apr. 12, 2012

(54) METHODS AND SYSTEMS FOR ENHANCED RESOURCE ALLOCATION

(76) Inventor: Russell W. Martin, New York, NY (US)

(21) Appl. No.: 12/902,019

(22) Filed: Oct. 11, 2010

(51) Int. Cl. G06Q 30/00; G06Q 10/00

(52) U.S. Cl. 705/14.4; 705/26.2

(57) ABSTRACT

A computer based system manages the collection and analysis of data on promotions and commerce supported by the promotions. The system in one arrangement includes a first web portal for harvesting promotion based data relating to commerce and a second web portal for bringing sellers of media channel inventory into communication with buyers of media channel space. The first portal includes a first programmed processor for collecting an identifier key associating a user with a selected promotion. Engagement is facilitated by one or more tools to actively build user specific data that characterizes the effectiveness of the promotion. A tracking methodology is implemented to further collect data associated with the user and the promotion in assessing promotion impact on commerce.

A second web portal is linked to a programmed processor and database. The processor implements an allocation algorithm that assists in pricing promotions based on the promotions effectiveness as measured by user responsiveness thereto. This processor further facilitates the second portal establishing a protocol to permit sellers and advertisers to interact so as to buy and sell promotion channels that are optimized for use in the commerce of selected goods and services.

### FIELD OF THE INVENTION

The present invention relates to computer systems and networks that permit digital communication among a large population of participants in a networked resource allocation and commerce system. The invention includes overlapping features and technologies found and disclosed in co-pending U.S. patent application Ser. No. 12/135,788 titled “Methods and Systems For Providing Advertisements” (the '788 application), to the applicant here and commonly assigned. application Ser. No. 12/135,788 filed on Jun. 9, 2008 is hereby incorporated by reference hereto in full as if restated in its entirety herein.

### BACKGROUND OF THE INVENTION

Network communication platforms such as the Internet offer a rich array of potential commerce. Online commerce may be facilitated by enhancing the information available and delivered to participants during online sessions on the worldwide web (“web”). As the number of participants has grown exponentially, the complexity and difficulty in organizing communication between relevant participants on the internet to support transactions has also grown.

Transactions can be facilitated by the using a number of promotional channels on the web and off. Examples of web-based promotions include banner ads placed onto content rich web pages where the banner ad includes an embedded link to a web-based merchant. Examples of off-web, or offline, promotional channels include broadcast television, broadcast radio, print outlets such as newspapers and magazines, and billboards. In the above-noted pending application, promotions are provided on separate pieces of transactional mail, which thus forms yet another off-web promotional channel.

The tracking of web promotions, such as web page banner ads, is known in the art and its ease of implementation is facilitated by the digital environment in which online promotions are distributed. Tracking of online transactions is easier because both the promotion and the user-interaction with the promotion, are digital transmissions using a defined protocol (e.g., TCP/IP). Offline promotions however, such as billboard advertisements, are not digital, nor are user interactions with these offline promotions captured in any succinct way. Consequently, before the present invention, tracking such offline promotions lacked accuracy and precision, and was extremely costly and inefficient.

In addition to the above described problem, there exists a paradigm in the marketing/advertisement industry of viewing advertisement channels as separate and distinct. For example, a marketing group working on a campaign typically allocated marketing resources in segmented advertisement channels, such as an online advertisements, newspaper advertisements, etc. This “silo-ing” of different advertisement channels, if not managed correctly, resulted in misallocation of scarce marketing resources. Stated differently, this paradigm led to “losing the forest for the trees” since advertisers attempted to optimize their marketing campaign within a media channel, instead of focusing on how to optimize their product promotions across multiple diverse media channels. Prior attempts to optimize a multi-channel marketing campaign across diverse media channels, before the present invention, have been unsuccessful.

### OBJECTS AND SUMMARY OF THE PRESENT INVENTION

Illustrative embodiments of the present invention preferably include a digital engagement tool for linking a promotion with a transaction by a participant. An exemplary engagement tool includes a code or “key” associated with the promotion that is harvested by the network. This key can be unique to that participant or shared with other participants. An example of a shared key is the use of a billboard with an associated identifier. An incentive, such as a coupon, may be provided to the participant to encourage engagement with the network. A web portal or similar interface is provided for harvesting the engagement tool and initiating the transaction. This can be through a personal computer, laptop, cell phone or tablet computer. Thus, leveraging the key and incentive, user interactions with offline advertisements can be recorded online and subsequently analyzed.

The engagement web portal may be equipped with supplemental measurement tools, for tracking participant engagement with select features of the web portal associated with the transaction. For example, the web portal may include a video, and participant conduct, such as engaging the video, and for how long are tracked and associated with that participant by use of the key. A survey may be employed and ultimately the system tracks commerce by the participant on the web portal. A database is linked and tracked activities are digitally organized and stored. In this way, meaningful performance parameters can be developed for different promotions, channels and products. Future promotions are adjusted with the feed back analytics extracted and processed from the database.

In accordance with the varying aspects of the present invention, the engagement web portal platform can be provided as a separately branded and dedicated portal for universal access and entry of engagement keys by users. In this way, the separately branded and dedicated portal is readily recognized by the user as the vehicle for access to the benefits supporting the promotion and the implementation of the key. Alternatively, the portal can be seamlessly included within a seller's web site, thus allowing the user to enter an engagement key directly with the seller associated with the underlying channel used to distribute the promotion. To accomplish this, the tracking software is placed on the web servers supporting the seller's web operations. A further alternative is to place the engagement key access portal on the Advertiser's web site, so that the user enters the key and engages at a site associated with the merchant. With this arrangement the Advertisers operate the tracking software off of this platform.

One aspect of the present invention, in essence, allows advertisers to track their offline ads, as well as their online ads, digitally and in a comprehensive manner. Because the present invention tracks different types of media channels, it further allows for the de-segregating of marketing campaigns by media channel, and for the tracking and optimization of entire marketing campaigns by using common measurements across different media channels.

In addition to the foregoing the present invention includes resources for allocating scarce promotional assets among sellers, advertisers and marketing professionals. Sellers of media channels suitable for the promotion of select goods and services are provided access to a commerce media site connected to potential users of these media channels. Advertisers and other brokers/buyers of promotional channels are likewise connected to the media commerce site to price promotion channels such as transactional mailings, outdoor billboards and the like. Web users are the target audience for the promotions and ultimately the products and services promoted in each media channel. The present system in one illustrative embodiment thus provides a media commerce clearinghouse for bringing advertisers and sellers together with associated marketing support to clear inventory of media channels through a rich array of analytic data regarding media channel performance.

The foregoing and other features of the present invention are further presented in conjunction with the following diagrams depicting a specific illustrative embodiment of the present invention of which:

### BRIEF DESCRIPTION OF THE FIGURES

FIG. 1 is a schematic diagram illustrating the information flows in the system operation;

FIG. 2 is an interface diagram;

FIG. 3 is a supplemental interface diagram;

FIG. 4 is a data flow diagram; and

FIG. 5-9 are supplemental flow diagrams; and

FIGS. 10-24 are screen shots of illustrative embodiments.

### DESCRIPTION OF THE INVENTION AND ILLUSTRATIVE EMBODIMENTS THEREOF

To illustrate the present invention, the following specific embodiments are disclosed, using nomenclature and terminology having well understood meaning specific to the industry specializing in online commerce. Simple glossary terms are provided in Table I below:

TABLE I
Glossary

| | | |
|---|---|---|
| 1. | Seller | Owner of the Product containing Space |
| 2. | Print House | Processes the Order, by displaying the |
| | | Campaign's Message on the Space; |
| | | May also be the Seller. |
| 3. | Advertiser | The buyer of the Spaces or party |
| | | representing the buyer |
| 4. | End User | The receiver of the Message |
| 5. | Order | Collection of the Spaces and Campaigns |
| | | presented to the Producer |
| 6. | Space | Ad space or the Accommodative |
| | | environment on the Product |

The present invention, in one arrangement, resides in a Commerce Management System (CMS) that operates on a public accessible network. A useful application of the CMS extends to the processing of engagement specific data. Specifically, the CMS includes program controlled data processing that measures consumer engagement across multiple media channels. Using software implemented algorithms and observations of consumer behavior, it adapts the messaging to optimize key performance metrics.

The process starts when a consumer receives a targeted message through a passive media channel, such as transactional mail, broadcast television, broadcast radio, outdoor billboards, or newsprint, et al. In a preferred embodiment, this message provides an incentive for the consumer to engage the network, such as a coupon or discount. The consumer engages with the targeted message by visiting a URL (or other digital engagement network) to submit a key, both of which accompany the message. The key can be unique, which is used to uniquely identify a consumer or it can be shared with other consumers (e.g, when it is printed on an outdoor billboard). The consumer uses a web browser on either a computer, mobile phone, or other device that allows a consumer to view the URL and submit the key, or alternatively uses other interactive features offered through such devices. The website or other engagement service that is associated with the URL is instrumented to track consumer behavior. This may include but is not limited to: whether the consumer watched a video and for how long, whether they filled out a survey, their answers to such surveys, how long they were on the site, and/or whether they purchased goods or services.

The consumer behavior data is stored, integrated with third-party data, and then analyzed to ascertain the messages and delivery mechanisms that work best for different types of consumers. For example, the system could determine that 95% of consumers stopped watching a particular 2 minute video after 15 seconds, thus indicating to the advertiser to shorten or replace the video. In another example, a utility company sells space on their monthly billing envelopes and provides individual key codes and advertisements based on the recipient's demographics (such as age). The system thus is able to indicate how successful a particular advertisement was to different demographic groups. Alternatively, if the seller does not have demographic information specific to each recipient, general demographic information is applied. For example, the same advertisement is provided to magazine A, with an average reader age of 21, and newspaper B, with a average reader age of 50, with a different key provided for each channel. Demographic information is extrapolated from the resulting interactions with the system. Accordingly, the CMS Analytics can help a marketer understand why a campaign met or did not meet their expectations. The marketing person can then use the information to refine their marketing campaigns. Specifically, the CMS targeting engine helps marketers to identify the appropriate ad channels, assess their impact and determine the frequency of use that optimizes the companies' promotion budget.

An optional feature of the site portal is providing users the ability to easily share the site. This sharing may be via entering an email address of a friend to whom the site may be of interest (for example, interest in the video or discount provided). Alternatively, the site may be shared through a social networking web site. The users accessing the site via sharing could be tracked back to the original user, and this data fed into the system analytics. For example, the system could determine that an ad with low engagement from primary ad recipients has high access via sharing by those users who did engage. Such information can indicate, for example, that the offline creative is not optimal, but that the online content is.

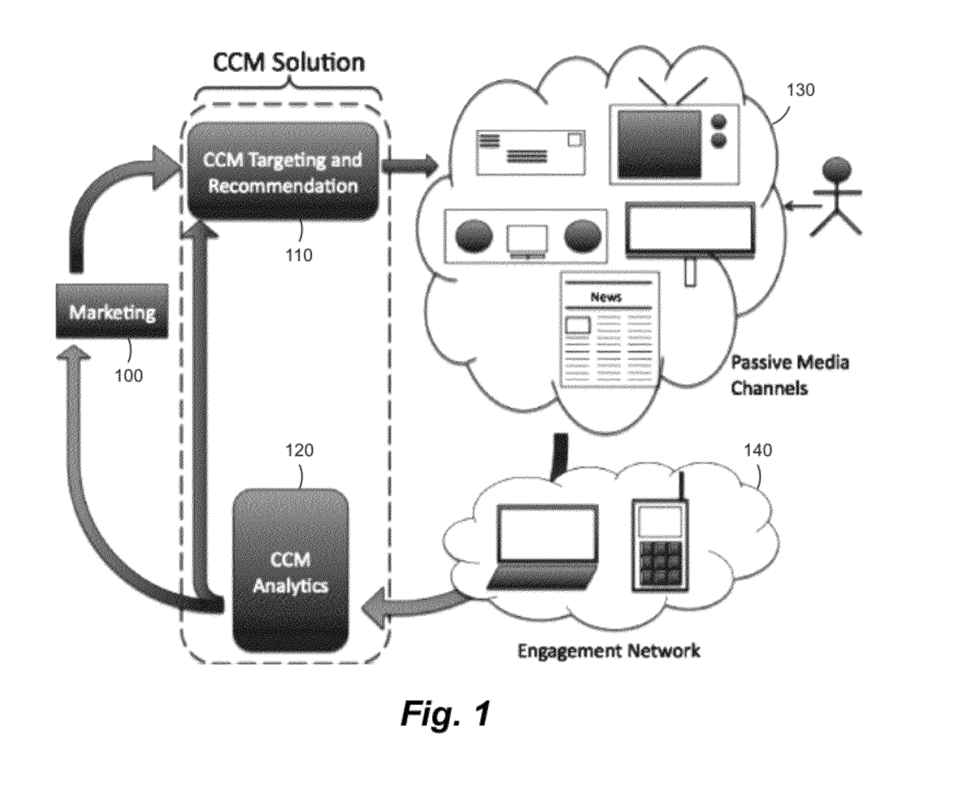

FIG. 1 illustrates information flows between various participants. The process is circular and thus provides a controlling feedback mechanism. Product Marketing Administrator, block 100, receives analytics from the Analytics Engine, 120, uses this information to assess and select channels and submits the channels per the recommendation outlets of block 110. Marketing programs for the selected channels are implemented in accordance with seller directed initiatives, block 130, utilizing a broad cross-section of passive media channels. In accordance with, per se, well-known response criteria, customer interactions are collected on the engagement network, block 140, illustrated here as cellphone or laptop links to network communications. The engagement activity is collected and stored, forming the predicate for assessing campaign success in the Analytic Engine, 120. The process continues and repeats.

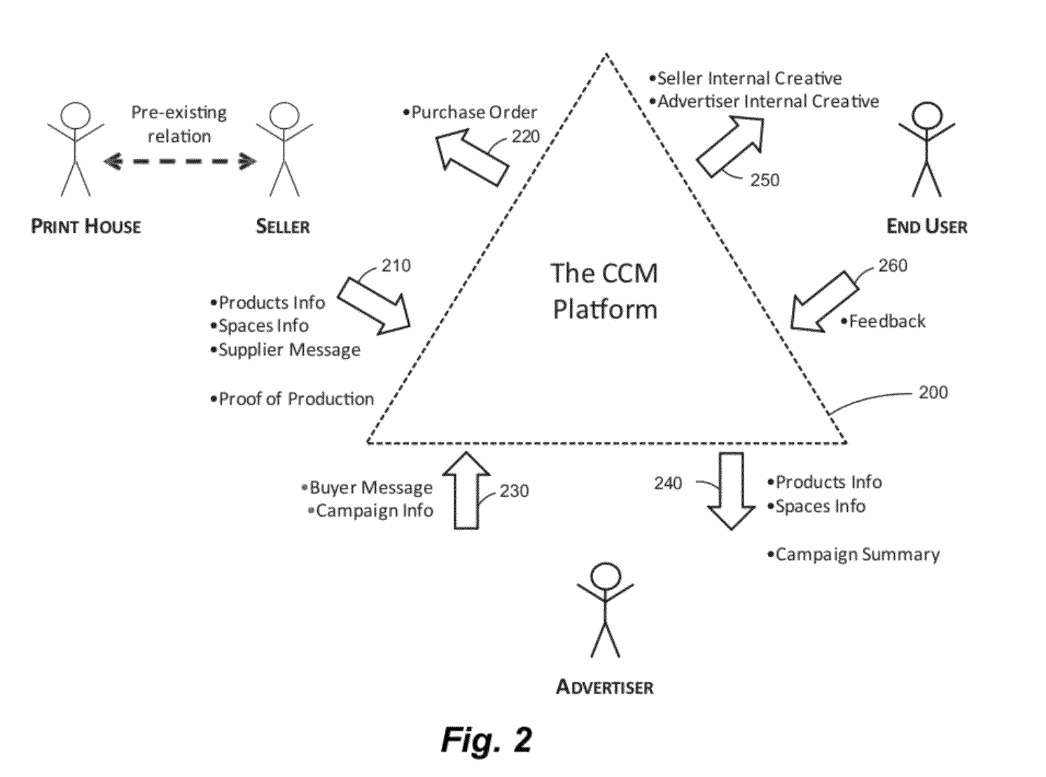

This platform is depicted in general terms in FIG. 2 as supporting a triangular interface that brings together three separate parties—Seller/Advertiser/End User. The platform, 200, is a computer system with network communications and client-server architecture. To illustrate this arrangement, the Seller is a utility that creates, using a print house, and distributes 300,000 statements by U.S. mail each month. Each envelope has sufficient space to support a single ad placement. The space requirements and print parameters are entered at input 210. If and when an advertiser purchases this space, a purchase order is provided at output 220. Other parameters for the Seller side of the triangle may be exchanged as is discussed in more detail below.

Continuing in FIG. 2, the Advertiser, who may or may not be the buyer of ad space, enters selected buyer message information and campaign data, input 230. An illustrative Advertiser is Apple computer, and an illustrative campaign is directed to the launch of a new handheld phone/computer. Output to the Advertiser, based on the Advertiser's input, will include information about the products containing ad space, information about the space (dimensions, color availability, etc), and a campaign summary, output 240. In this illustration, Apple may be represented by a marketing group responsible for administering promotions, or Apple may be acting on its own behalf.

In either event, the promotion and the Space Creative enters the stream of commerce, block 250, and eventually triggers End User response, block 260, forming the final interface to the platform. The system measures and assesses the response from the promotion and provides analytics to participants.

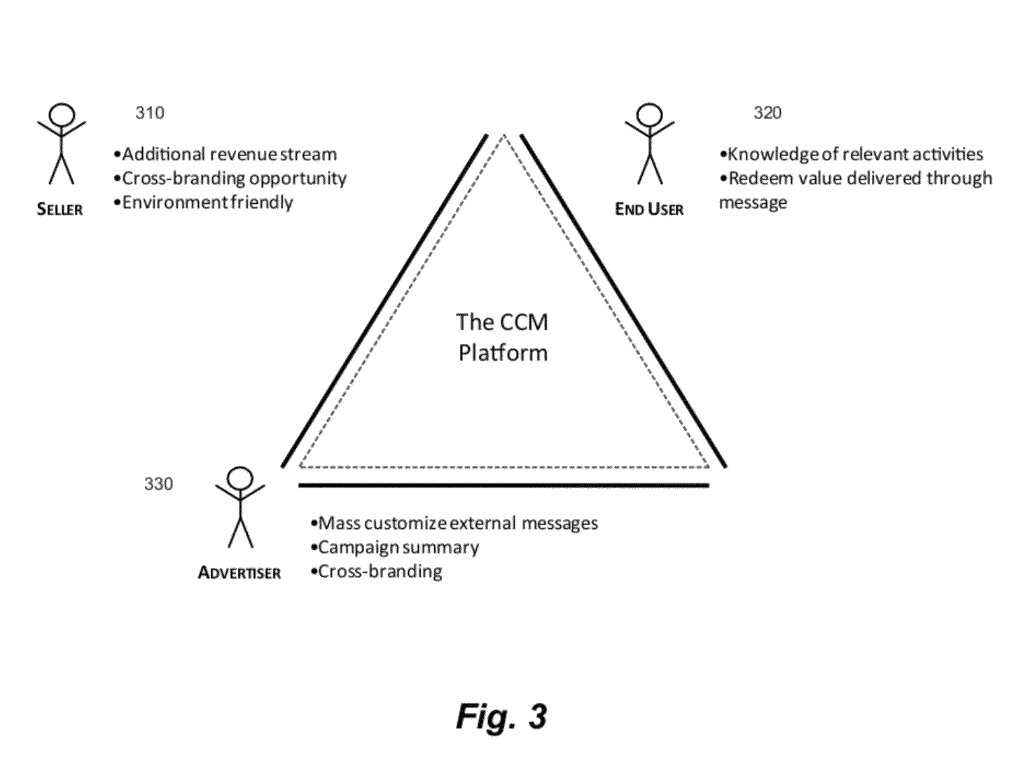

The system created incentives to each side are summarized in FIG. 3. Specifically, by using the system, the Seller, 310, generates additional revenue, and provides cross-brand advertising opportunities. Advertisers, 330, share in cross-branding opportunities and implement targeted, yet mass-produced promotions. Both share in implementing an environmentally friendly marketing process, since ads are not mailed/printed independently, offering yet another ancillary promotional topic (e.g., “Go Green”). Finally, End User, 320, enjoys simple, voluntary access to preferred goods/services without meaningful burden.

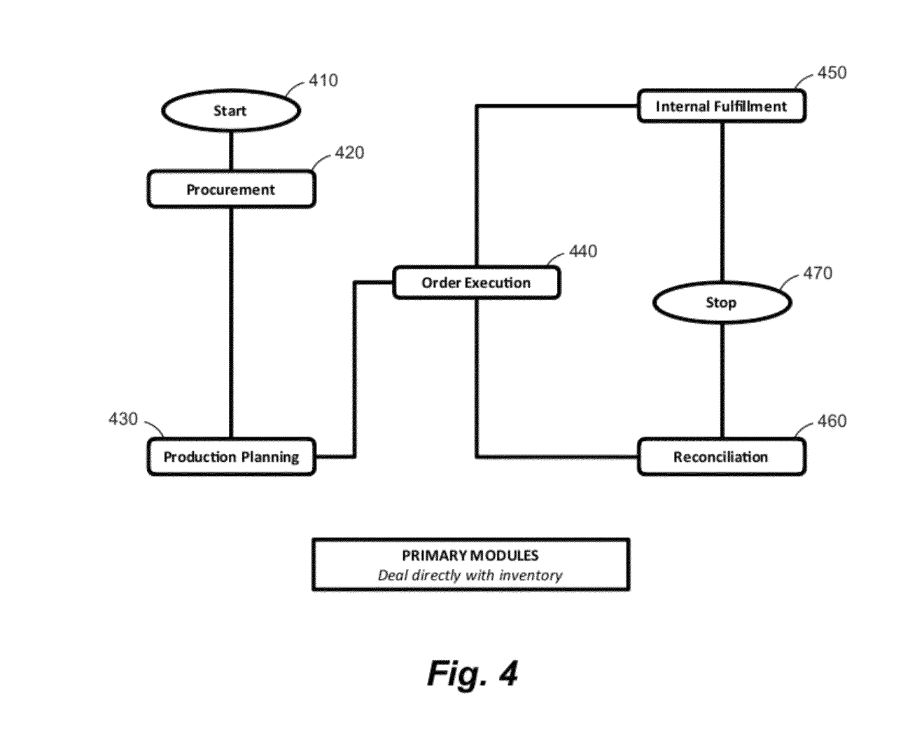

Turning now to FIG. 4, an illustrative system data flow diagram for the primary system modules is depicted. Start block 410 leads to procurement 420 and Production Planning 430. Collected information, once confirmed, is passed to Order Executor, 440. Upon completion, system logic continues with internal fulfillment, 450 and reconciliation, 460, and then terminates, 470. Each of these steps is described in further detail below.

Operation is continuous and self correcting, governed by the controlling Allocation Algorithm.

For a customer-facing portal for the ad-network, Sellers and Advertisers can enter their inventory details and campaign requirements, respectively. The system manages these and intelligently allocates inventories to campaigns in a way so as to maximize net profit for all three parties involved. Note that it is also possible for a single party to act as both the advertiser and the seller. This is the case when an organization delivers campaign messages on their own inventory; in one example, mailings.

Under system operation, the seller's inventory is viewed as supply and the advertiser's campaign is the demand. Before accepting new incoming campaign requirements, the system matches the existing supply to confirm that the demand can be met. This initial match is later used to prompt the actual allocation process. The actual allocation, facilitated in some instances with operator input, uses these matched accounts as suggestions and at starting point to allocate in less time with greater efficiency. The following algorithm explains how the suggested allocation is done.

TABLE II

| | | |
|---|---|---|
| 1. | Campaign components | Specifications, Cost per impression (CPM) range and budget |
| 2. | Estimated Inventory | Specifications, CPM and total number |
| 3. | Advertiser | Designates priority of the specifications |
| 4. | Campaign snapshot | Freeze data on both sides and compared with all available units of |
| | | Estimated Inventory [on the above 3 attributes] |
| 5. | Quantitative and control | Develop estimation threshold and compatibility score for each side |
| | criteria | of transaction |
| 6. | Possible outcomes of this | a. Campaign is submitted successfully |
| | comparison | b. Campaign cannot be submitted and this is communicated to the |
| | | Advertiser |
| | | c. Campaign requirements with minor system—suggested |
| | | modifications are displayed as options to the user to choose |
| | | from |
| 7. | To arrive at any of these | When the original campaign is submitted, the system gathers all |
| | outcomes | the available units of estimated inventory and progressively pares |
| | | down the list by eliminating the inventories that are not |
| | | satisfactory based on system specified attributes at each step of |
| | | comparison. |
| 8. | Step 1 | Inventories not in the CPM range of the campaign are removed |
| | | and all inventories with same category are eliminated |
| 9. | Step 2 | Every inventory is given a compatibility score based on how well |
| | | its specifications match the specifications of the campaign and on |
| | | how well the inventory is expected to perform given historical |
| | | data. The performance is calculated in terms of goals (e.g., |
| | | conversion rates, return on investment) defined by the Advertiser. |
| | | Individual specifications can be weighted to communicate how |
| | | much the algorithm should factor it in to its compatibility score. |
| 10. | Adjust compatibility scores | Better performance and better matches across specifications input |
| | | matching results; apply compatibility calculation: result in higher |
| | | compatibility scores |
| 11. | Enter new score | Every inventory specification is provided a compatibility score |
| | | greater than the estimation threshold, which is a value initially set |
| | | to eliminate mismatches |
| 12. | Calculate weighted | Apply assigned weights according to the priority previously |
| | compatibility score | chosen by the Advertiser |
| 13. | Calculate final inventory-score | Based on the average of all its weighted compatibility scores |
| 14. | If there is a perfect match | the campaign is allowed to be submitted immediately; otherwise |
| 15. | Else, | The list of potential options—a sorted list of inventories in |
| | | descending order of the inventory-scores. Several of these are |
| | | picked and returned to the user as suggested alternatives |
| 16. | If the list has no potential | A message communicating that there are no inventories available |
| | inventories | now is displayed |

TABLE III
Definitions

| | | |
|---|---|---|
| 1. | Estimated | Seller's asset available in the customer response |
| | Inventory | system |
| 2. | Campaign | Details of the Advertiser's promotion |
| 3. | Estimation | Minimum value of the compatibility score to |
| | threshold | consider the campaign and inventory, a match |
| | | based on that particular specification |
| 4. | Compatibility | Numerical score indicating the degree of match |
| | score | between a campaign specification and inventory |
| | | specification |
| 5. | Weighted | Compatibility score weighted according to the |
| | compatibility | priority as set by the Advertiser user |
| | score | |

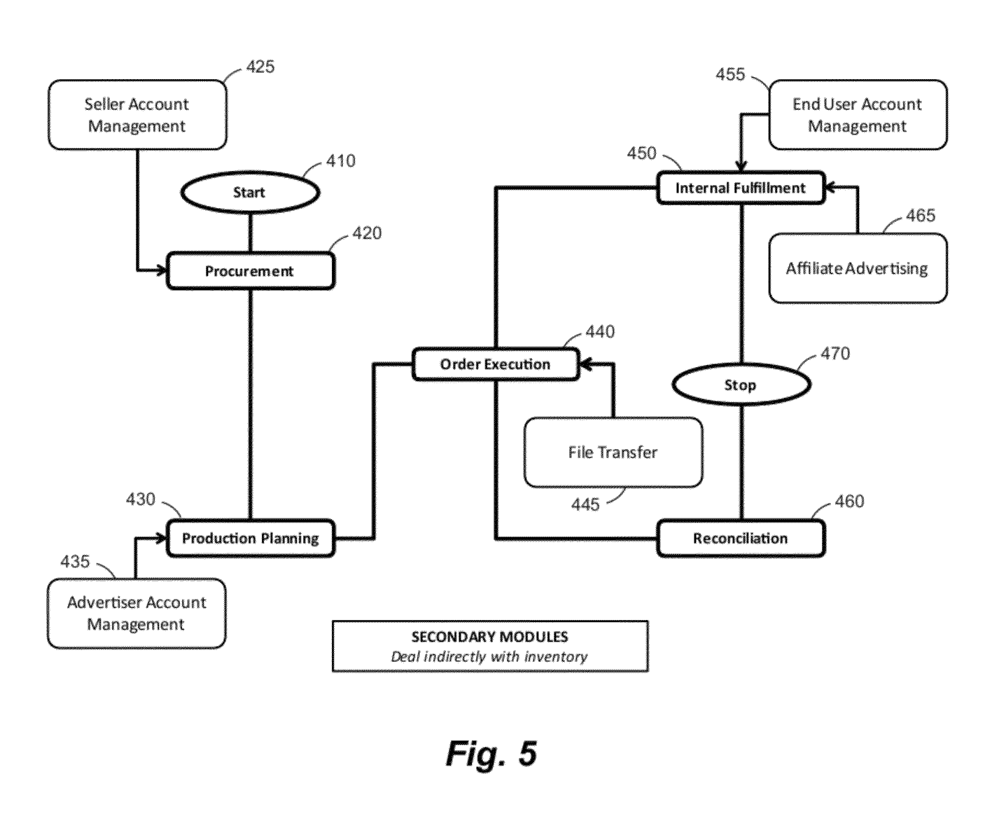

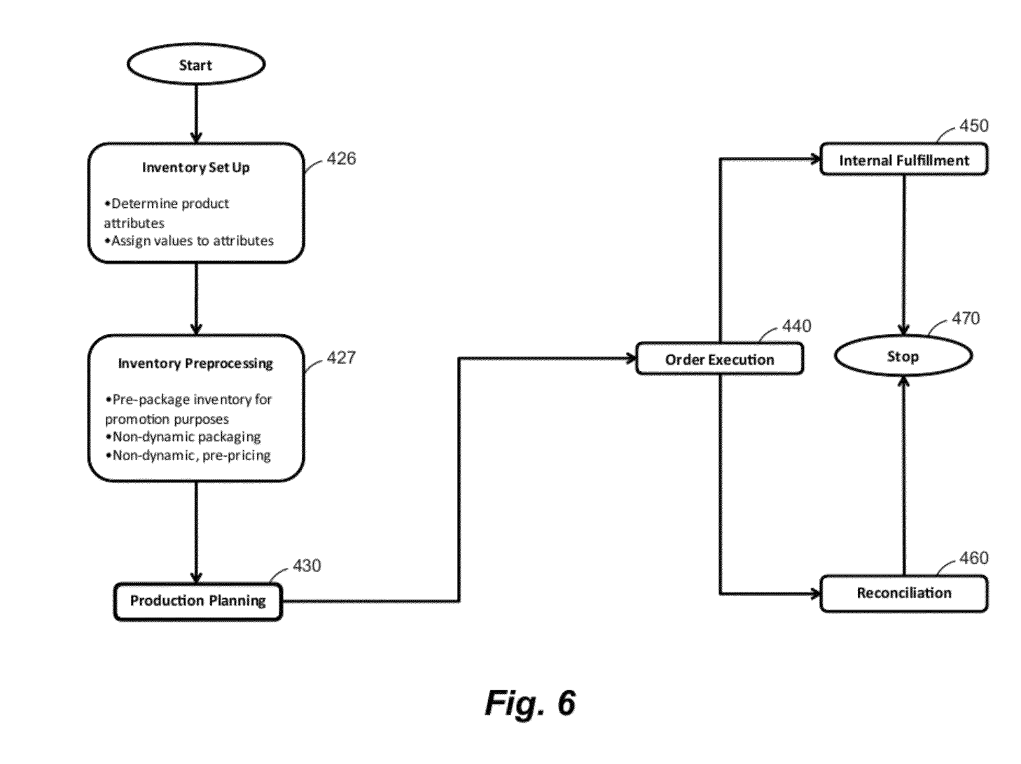

The primary modules of the system architecture are supplemented with system secondary modules. These are depicted in FIG. 5 linked to the system primary framework. The modules and steps described are not all required, and/or may be implemented by combining or dividing steps. In the arrangement of FIG. 5, Procurement 420 is connected to Selling Account Management 425. Operations of these modules include inventory set up and inventory pre-processing. (See FIG. 6, block 426, and block 427). As shown in FIG. 6, the system characterizes Inventory of promotional outlets to commoditize the format; here as a series of product “attributes” with assigned “values,” block 426. A preprocessing of the inventory (block 427) confirms the data set for further operation.

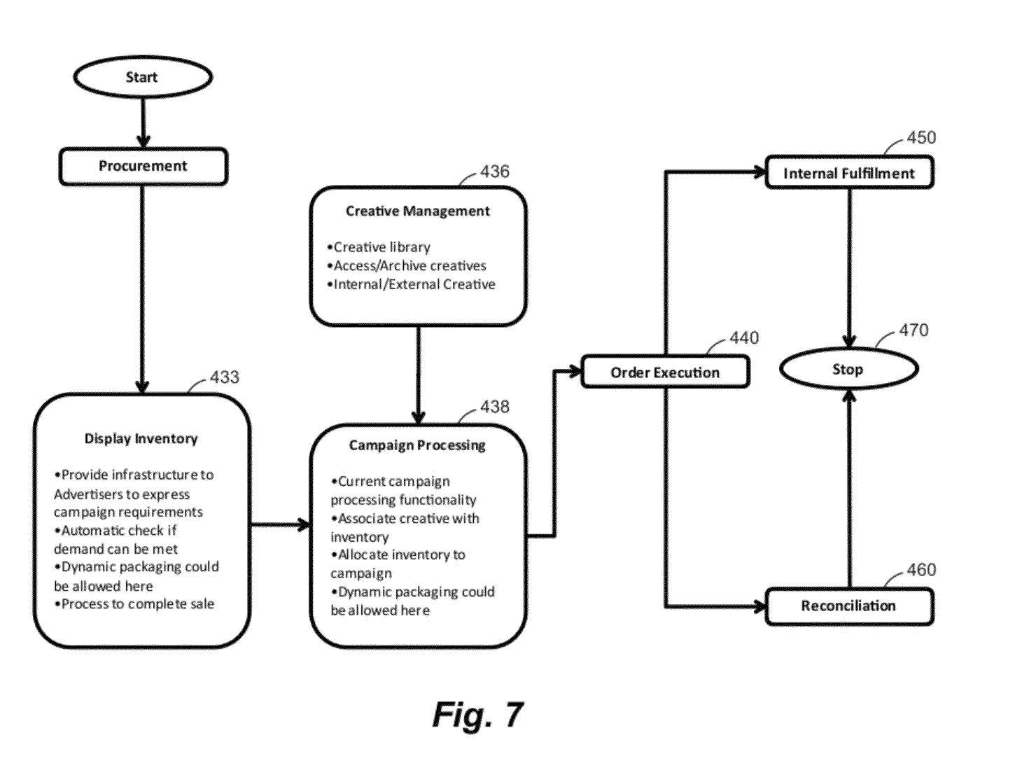

Returning to FIG. 5, Production Planning 430 includes secondary module Advertiser Account Management (“AAM”), block 435. These modules are described more completely in FIG. 7 in reference specifically to Inventory Display, block 433, Creative Management, block 436, as assembled by Campaign Processing, block 438. In operation, an interaction portal is provided to Advertisers to enter/select Campaign requirements and to assess if Inventory can meet expected demand. Dynamic Packaging is implemented where appropriate.

Continuing in FIG. 7, Ad Creatives stored in the “Creative Library” are accessed, block 436; alternatively, external sources for the creation can be accessed and used. Taking the selected entries, the system facilitates the final campaign build, block 438. Here, the current campaign functionality is set, the creative is placed in association with the promotional placement, and inventory is allocated.

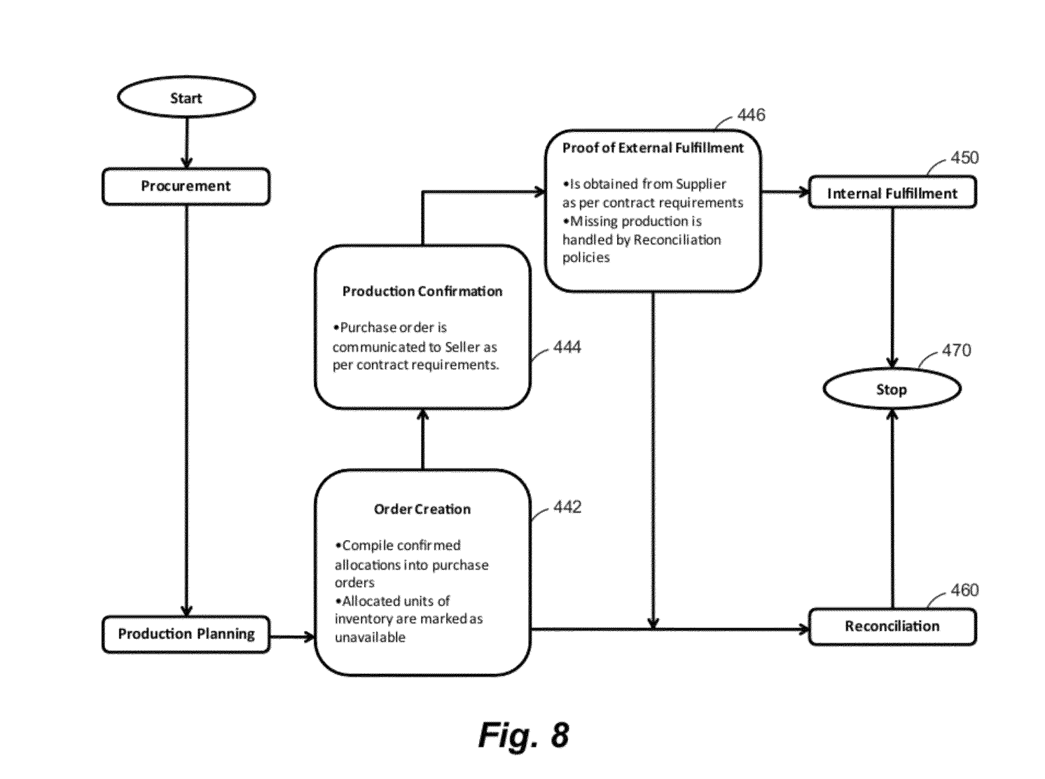

After Production, the system Executes the Order, block 440, supported by secondary module file transfer, 445. These modules are further described in blocks Order Creation, 442, Production Confirmation, 444, and External Fulfillment, 446. (See FIG. 8). Execution invokes compiling confirmed allocations into Purchase Orders, and removing allocated units from available inventory, block 442. The compiled purchase order is communicated to the seller, block 444 (per contract) and the External Fulfillment database is updated with confirmation from supplier that the order has been fulfilled, or identifying missing production, block 446. Identified missing production data is passed on for reconciliation, block 460.

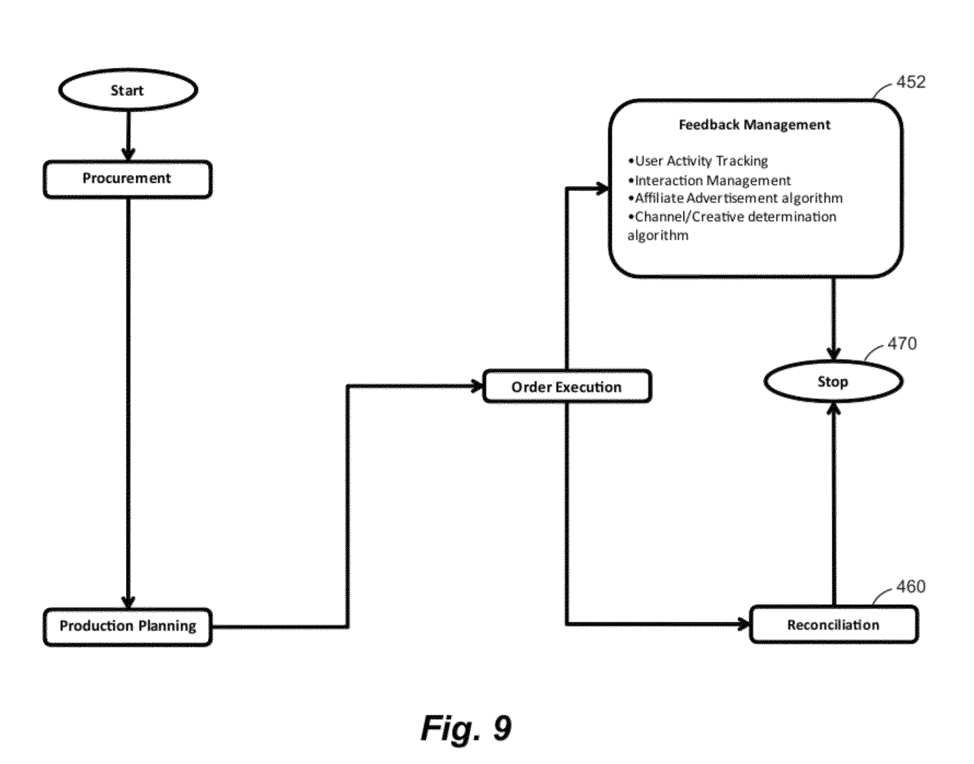

Continuing with FIG. 7, block 450, represents the primary module for managing/tracking Internal Fulfillment. This is explained in more detail at block 452, FIG. 9, delineating the feedback mechanism, where the system tracks User activity and implements the Affiliate Advertising Algorithm (“AAA”) and the Channel/Creative Algorithm (“CCA”).

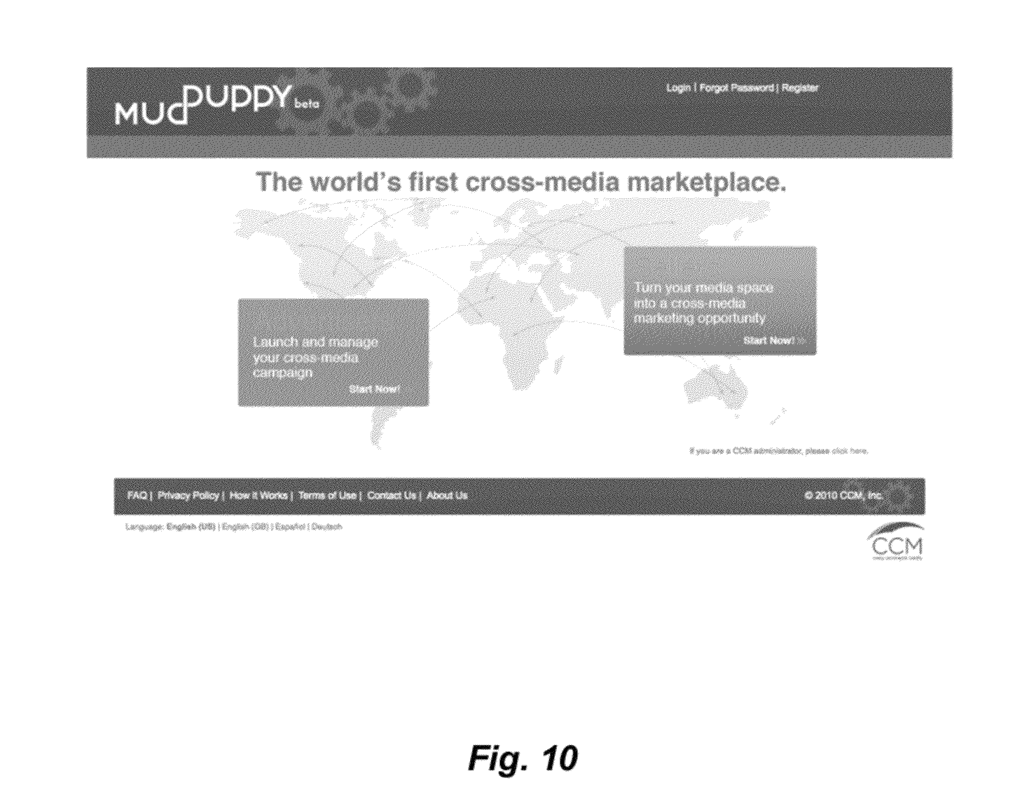

Network-based operation is depicted via the next series of Figures (FIGS. 10-24), where navigation through an enhanced portal/interface permits controlled access and implementation of system operative features. Beginning with FIG. 10, login operation is coupled to bifurcated access to either Seller or Advertiser operations. In this illustration, the first series of screens are triggered by entering into the “Seller” side.

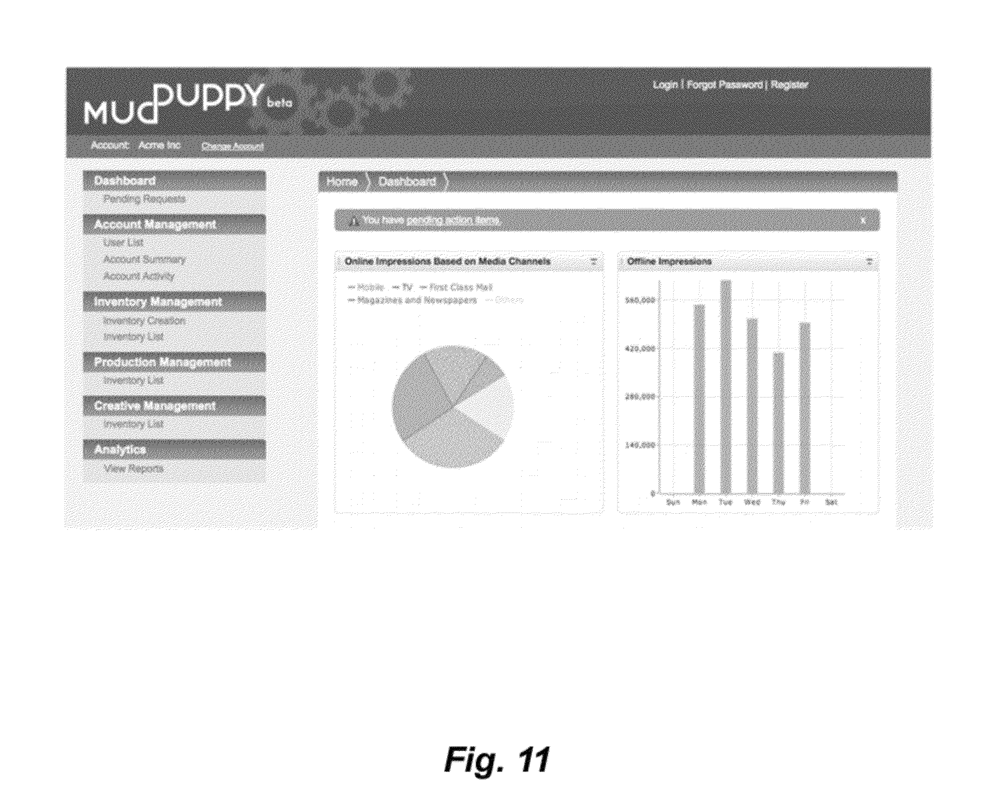

In FIG. 11, the Seller ID triggers the first data presentation, here for the ACME Corp as identified e.g., by login credentials. System programming provides two panels on this opening screen. On the left, a series of context sensitive operations are listed vertically and include “Dashboard,” “Account Management,” “Inventory Management,” “Production Management,” “Creative Management” and “Analytics.” On the right, a panel is opened in Dashboard—a facility for managing pending requests by that Seller—ACME. Two windows depict online and offline impressions related data, respectively.

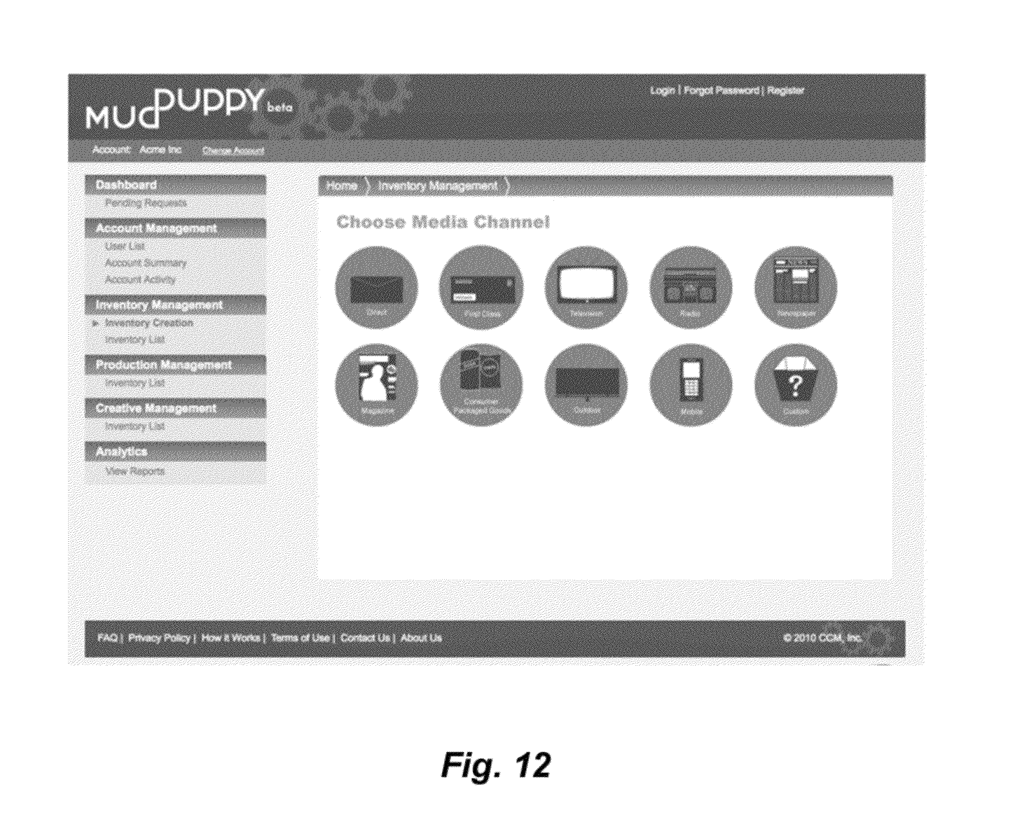

The opening window provides entry into task/function operations from the Seller, a perspective of current activities, and opportunities and a notification regarding pending action items. It is also the process start for the promotion auction function supported by system programming and the review of market/promotion analytics. The promotion auction could be used to sell the Seller's ad space to the higher bidder. Alternatively, prices could be automatically set by the system, negotiated with individual Advertisers, or set by the Seller giving the Advertiser the option to buy space at that particular price. The Seller could also offer discounts for buying higher volumes of ad space. Alternatively, each of these price determination options could be initiated by the Advertiser. Moving through the task/operation list on the left of FIG. 11, selection of e.g., Inventory Management opens a new view in the right side panel of the screen—offering a selection of media channels. This is shown in FIG. 12, and the icon-based presentation provides the following:
1. Direct 6. Magazine
2. First Class 7. Consumer Packaged Goods
3. Television 8. Billboards (or outdoors)
4. Radio 9. Cellphone (or mobile device)
5. Newspaper 10. Custom

As discussed above, the foregoing channels operate by User entry of a code coupled to a promotion/offer. The level of targeting is tied to the channel. Direct mail pieces are very User targeted while a billboard is less so. A billboard, however, has some potential targeting attributes based on e.g., location, such as commuters (highway), vacations (shoreline), etc.

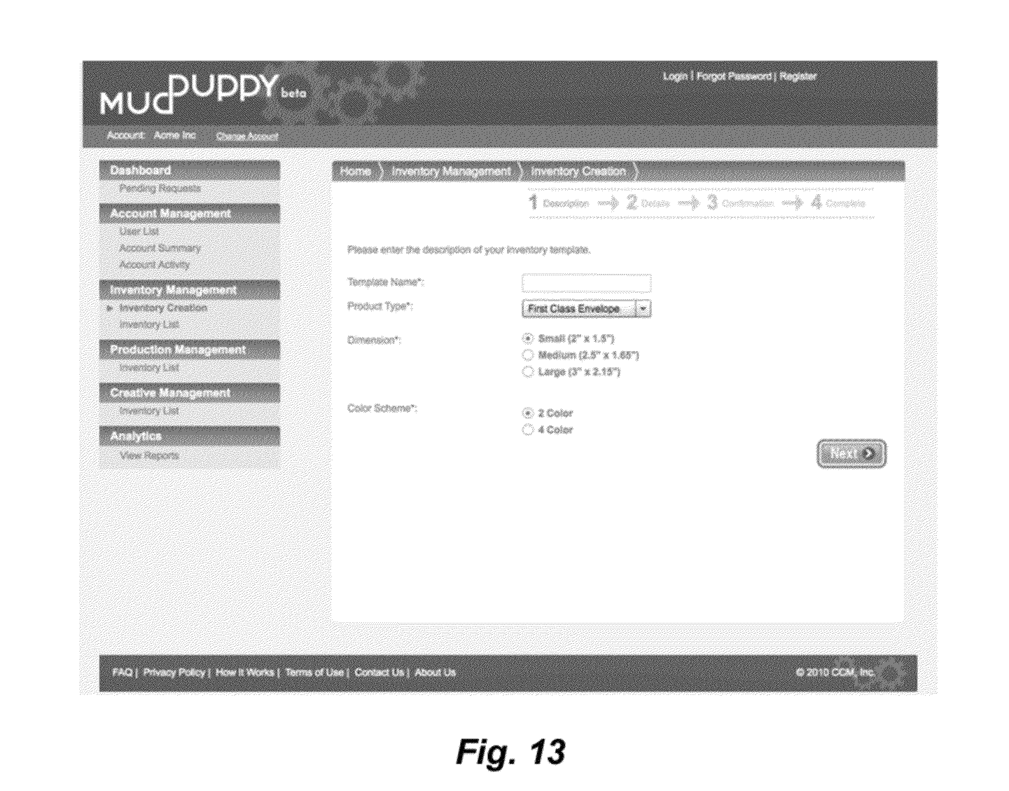

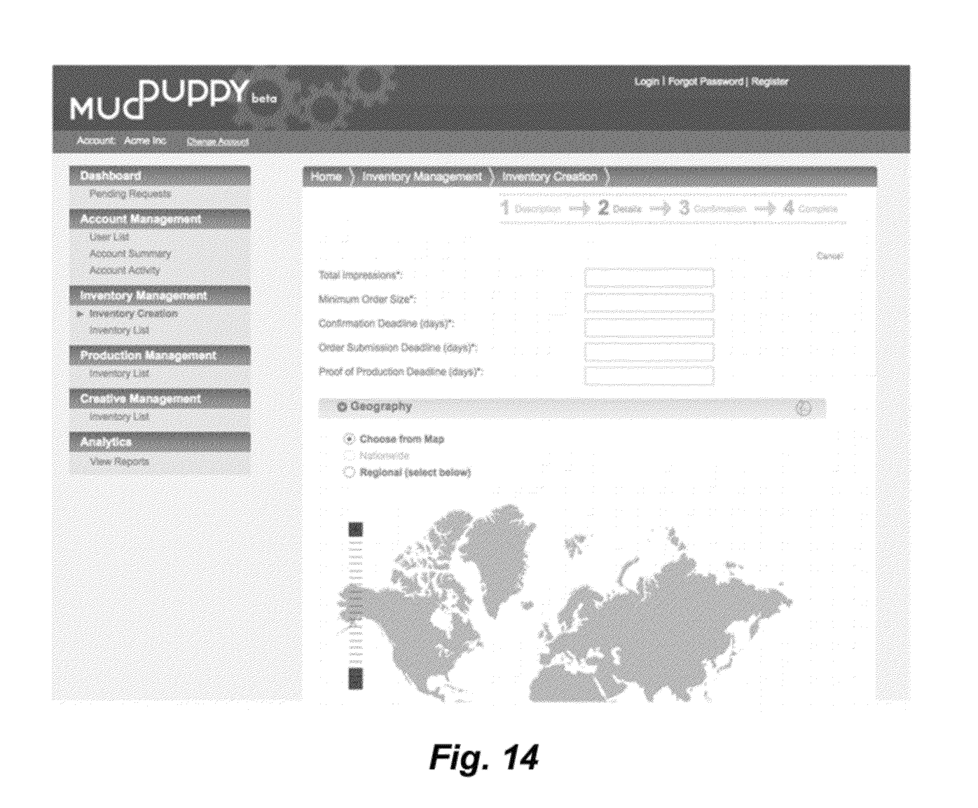

Continuing in FIG. 13, the Seller builds inventory by entering details regarding its channel. For mailings, this will include “envelope size” and “color.” Similar inventory data collection exists for each of the Seller's channels, and upon completion, Inventory is accumulated. In FIG. 14, other attributes for the new entries are collected, including total numbers of impressions, and geographic reach or Designated Market Area (DMA)—national, regional, state specific, etc.

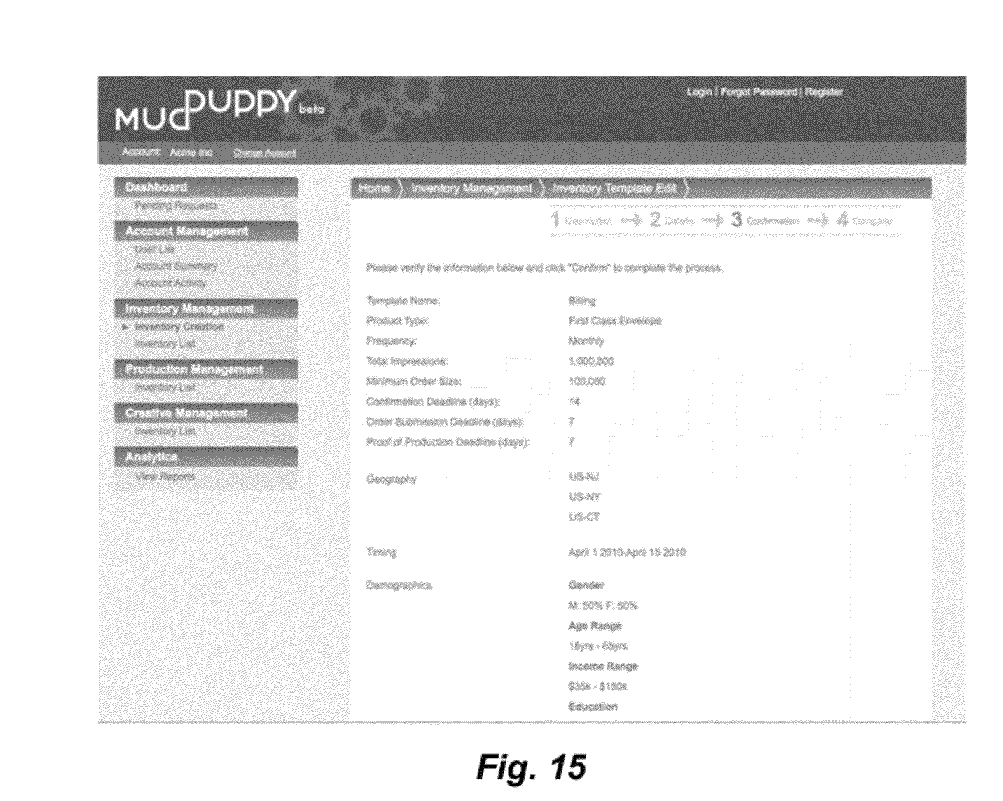

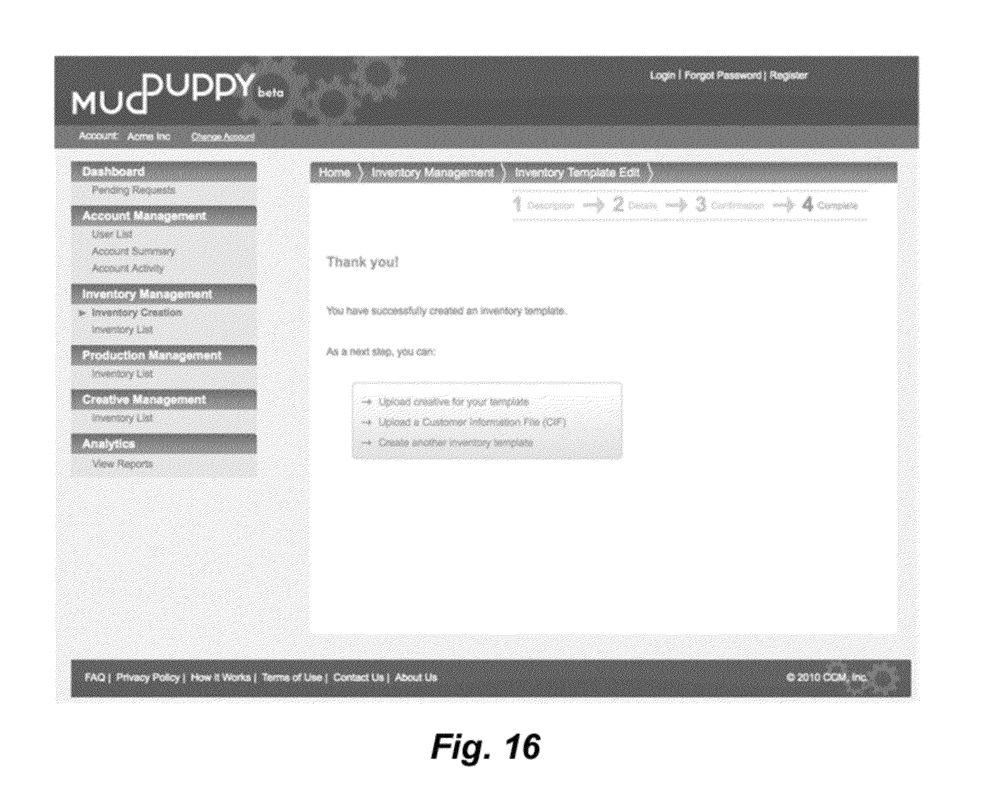

In FIG. 15, an Inventory Template is constructed specific to a mailing offer. Demographics for the mailing channel are provided and particulars about the Seller supplied Inventory. Demographics could include, for example, age, sex, income range, etc. For example, a minimum order size of 100,000 is set for a mailing by this Seller. Once completed, as shown in FIG. 16, the template can be uploaded into the system for use by administers.

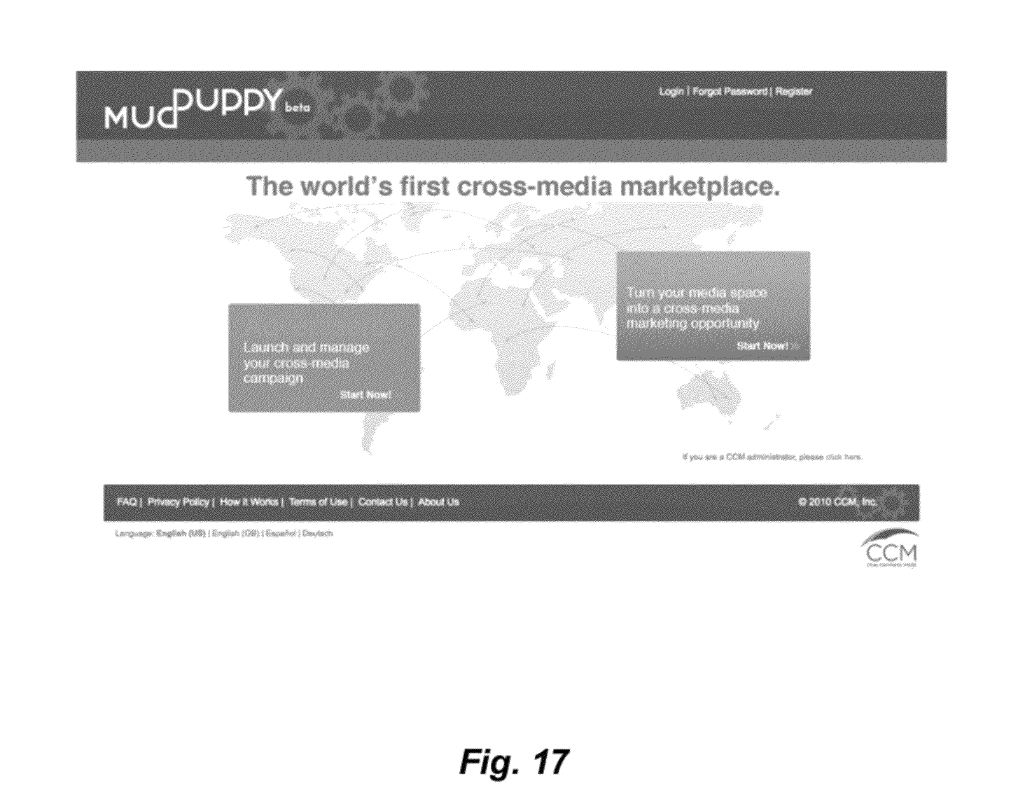

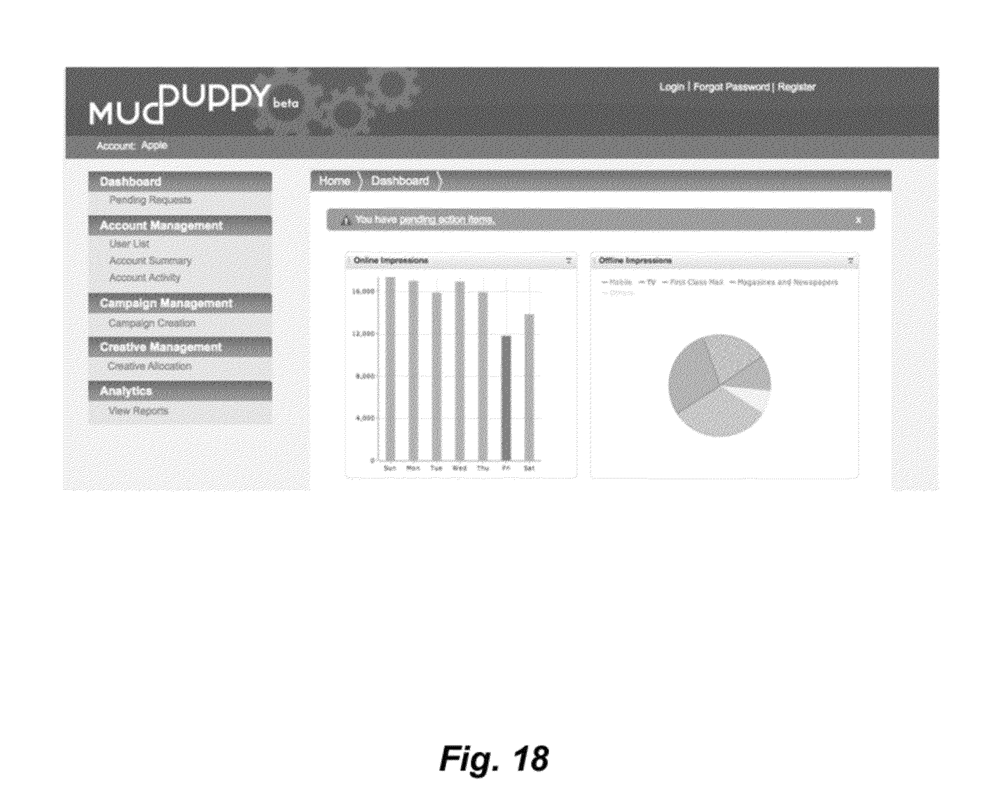

Turning now to FIG. 17, the opening screen is re-presented offering selection and entry to the Advertiser side of the marketplace. Upon selection and entry of password and ID, an advertiser specific screen is presented, FIG. 18, offering bifurcated panels similar to that on the Seller side. For the illustration, Apple computer is the Advertiser, and the “Dashboard” includes function/operation links to “Account Management,” “Campaign Management,” “Creative Management” and “Analytics.” An initial results summary is graphically presented for both on-line and off-line impressions for this Advertiser.

The system provides for both graphical and text/numeric output of analytics produced from the collected data. These analytics include, but are not limited to, demographics based on ads, advertisement conversion rates based on ad channel, ad conversion based on time or displayed as a timeline, ad conversion based on ad channel and based on time, portal site interaction statistics (such as time spent watching videos), portal site statistics based on ad channel and/or demographics, etc. The term ad conversion in this context meaning the number or percentage of users that accessed the portal site using a key; however, other criteria known in the art could be used, such as the number of impressions, or users who accessed the portal site and purchased a product or filled out a survey, etc.

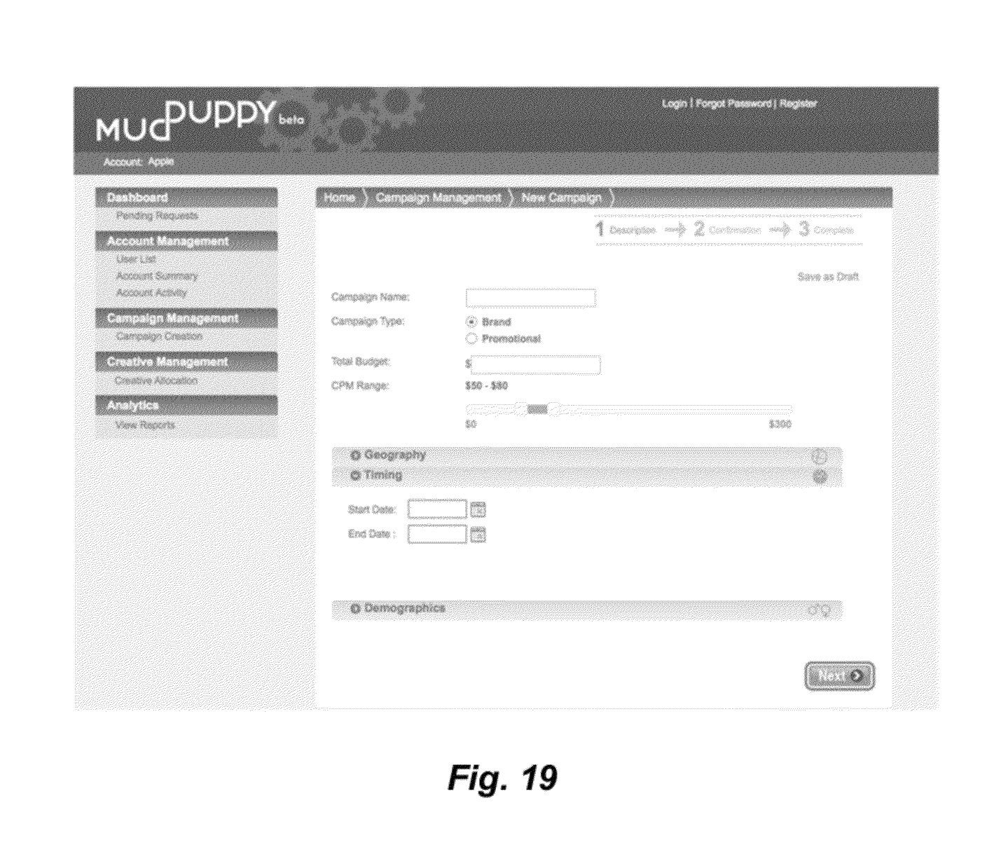

Turning now to FIG. 19, the Advertiser enters the New Campaign Panel where the Advertiser is able to specify the parameter of his or her desired new campaign. For example, the Advertiser can indicate the type of campaign (brand or promotional), total budget, the CPM range, the DMA or geographic region to be targeted, ad channels not to be used or that must be used, the start and end date of the campaign, the target demographics to be reached, etc. Alternatively, the Advertiser can simply enter a goal, or a goal and some of the above mentioned criteria such as budget, and them system can proceed to the next step.

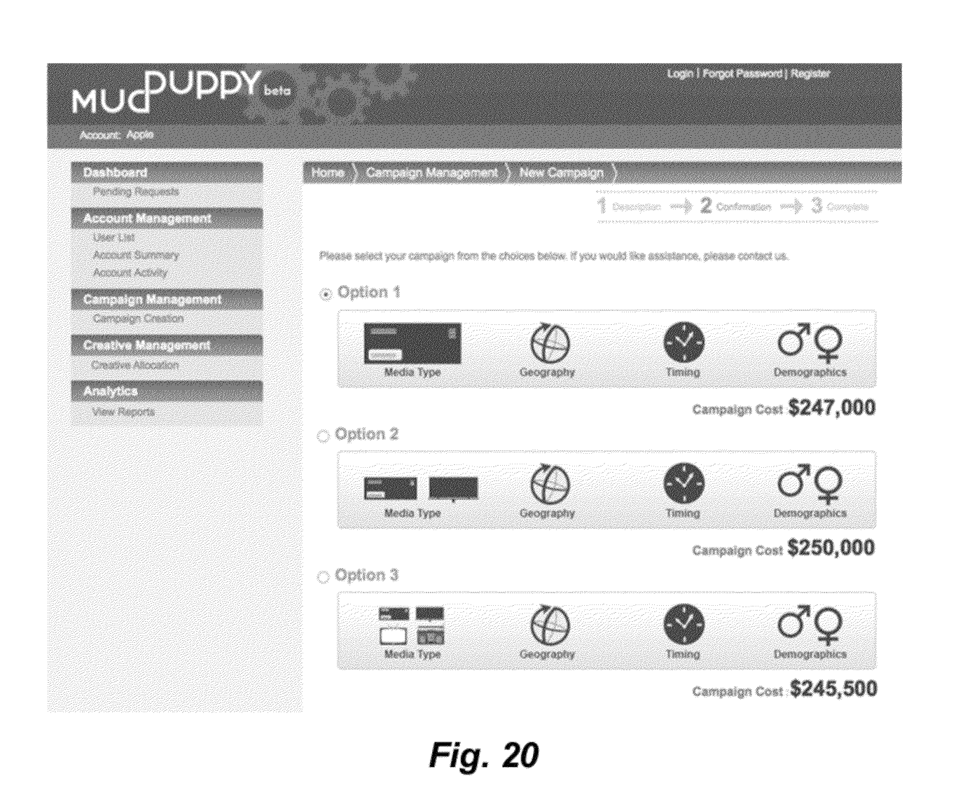

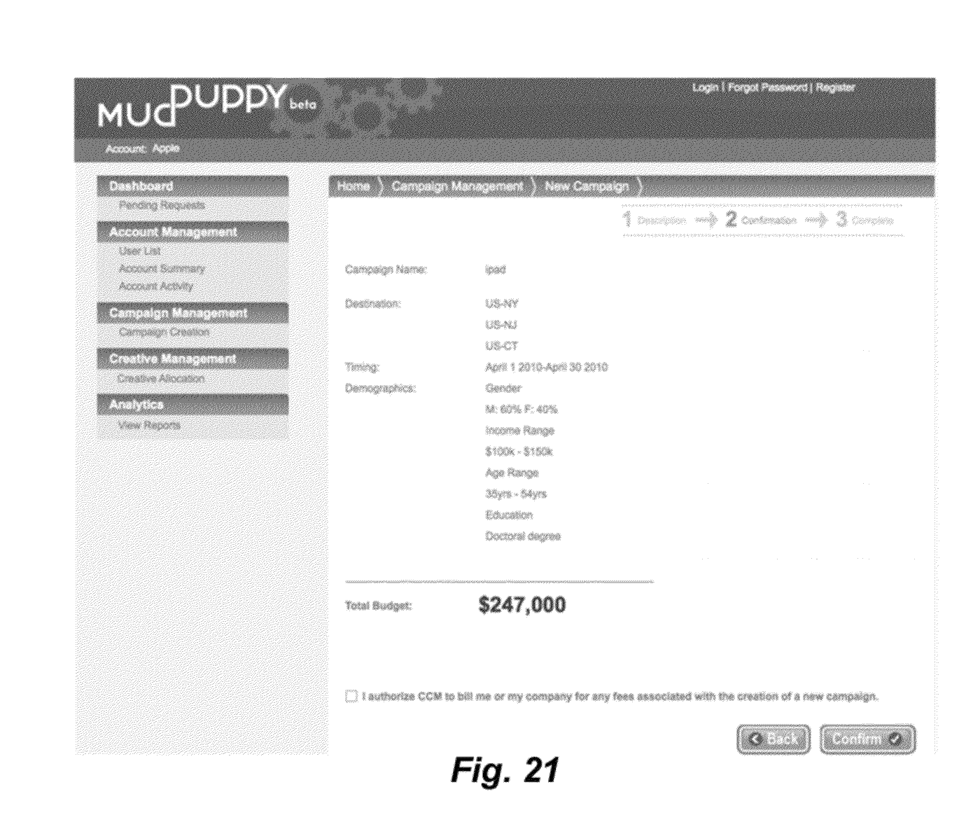

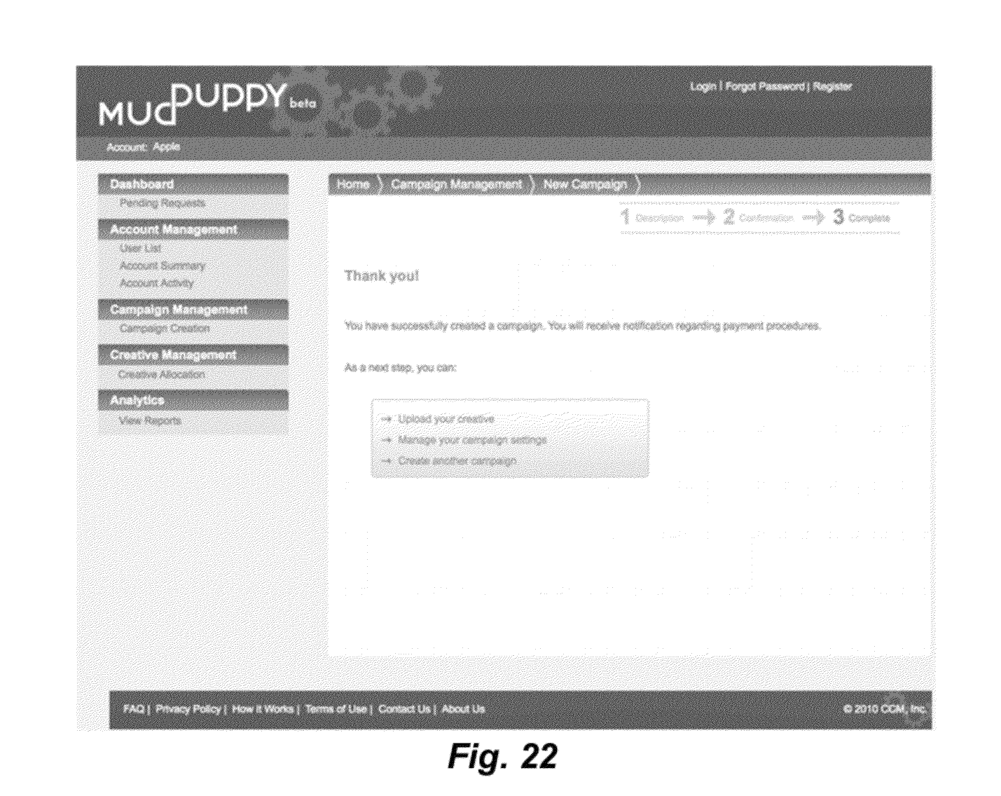

Continuing with FIG. 20, based on the parameters entered by the Advertiser, the system, using the algorithms described previously, for example using past data, suggests a plurality of recommended campaign options. Optionally, the system can specify a preferred campaign out of those suggested. As shown in FIG. 20, the cost of each campaign as well as the media type(s) (to be used with each campaign) is shown. Since common measurements are used across different media channels, the system is able to recommend where (ad channel, region, demographic, etc) advertising funds are best deployed. The geography and timing may also be displayed, or may be displayed on a subsequent screen with further details of the selected campaign, such as demographics to be reached by the campaign, as shown in FIG. 21. The Advertiser can confirm this Campaign as quantified, FIG. 22, with the System matching the results with the stored Seller side inventory.

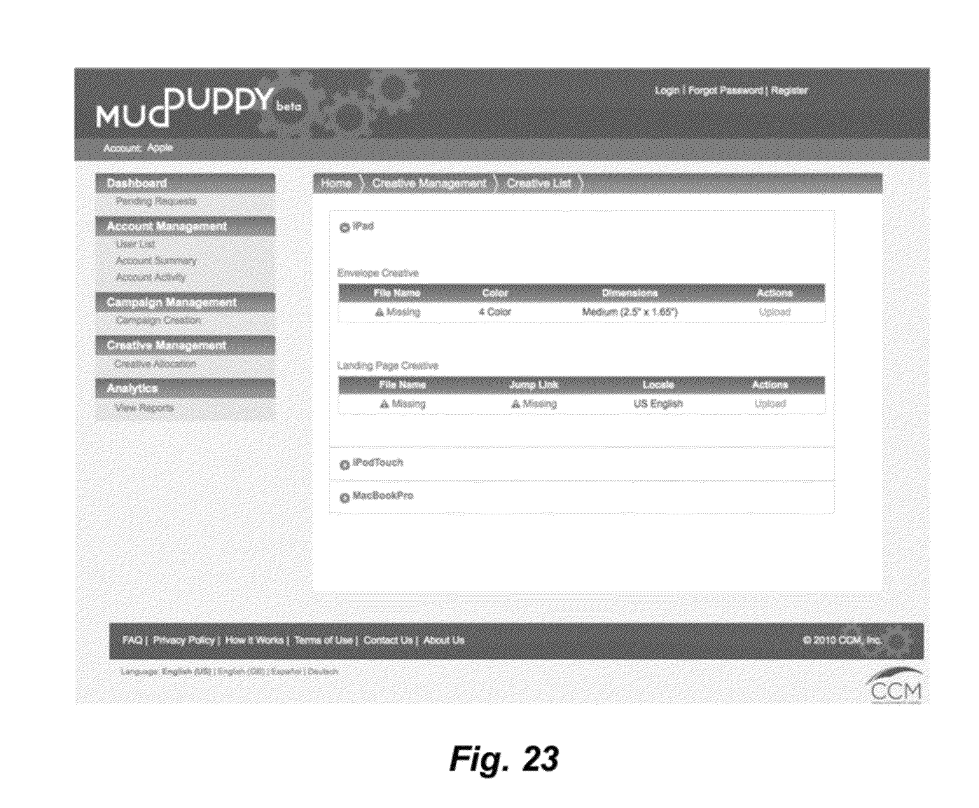

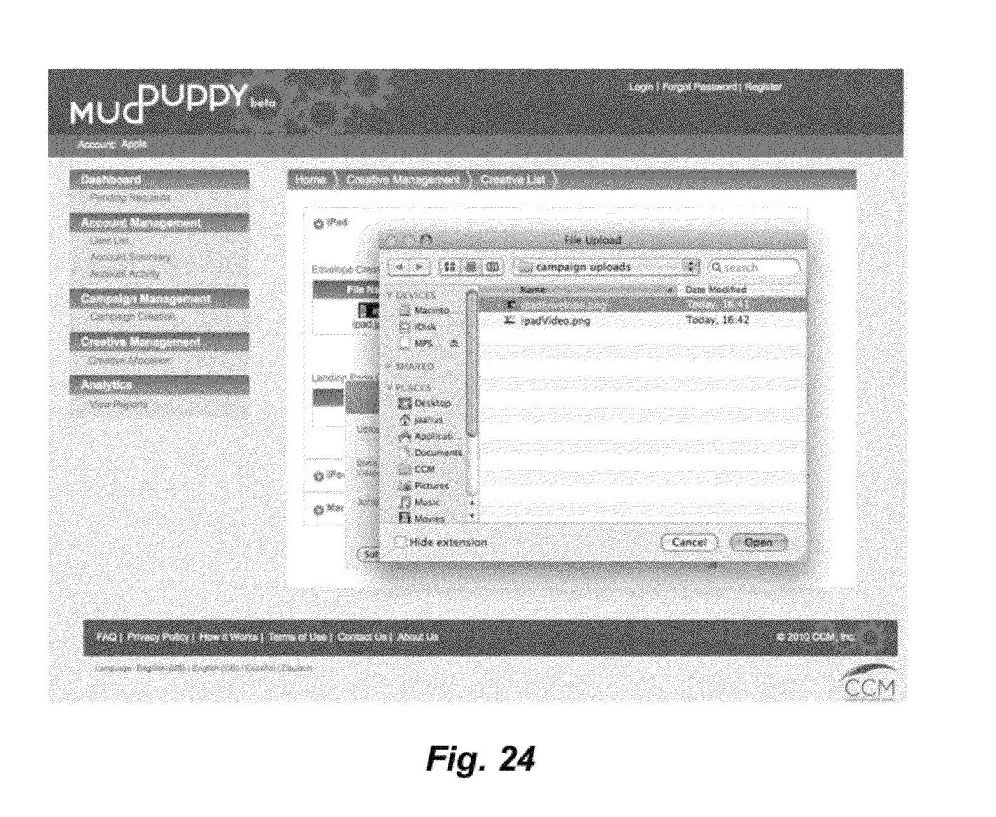

The next screen, FIG. 23, shifts the project to the “Creative” for use with the promotion. In this module, the Advertiser selects from various options the parameters from the Creative used in conjunction with the envelope; also customizes the Web-page identified with the promotion for the particular product attribute—here an iPad™. Once finalized, the Creative file is uploaded for implementation with the Campaign, FIG. 24.

For ease of exposition, not every step or element of the present invention is described herein as part of software or computer system, but those skilled in the art will recognize that each step or element may have a corresponding computer system or software component. Such computer system and/or software components are therefore enabled by describing their corresponding steps or elements (that is, their functionality), and are within the scope of the present invention.

While the invention has been particularly shown and described with reference to a preferred embodiment, it will be understood by those skilled in the art that various changes in form and detail may be made therein without departing from the spirit and scope of the invention.

What is claimed is:

1. A computer based communication system for managing allocation of commerce promotion channels, comprising:
a data processor with program-controlled operation for implementing said commerce allocation in accordance with an allocation algorithm, said system processor further comprising:
a first communication link to support information transfer to one or more Sellers when said Sellers have available inventory of commerce media channels to enter for system processing;
a second communication link to Advertisers when said Advertisers input proposed promotional messages for use on said media channels;
wherein said processor selectively allocates media channel inventory to said Advertisers based on said allocation algorithm; and
a data analytic engine to create Campaign-based performance measurements for output and review by said Sellers and/or Advertisers.

2. The computer-based communication system of claim 1, wherein said allocation algorithm receives input of a proposed Seller inventory and a proposed Advertiser campaign and thereafter match portions there-between based on stored compatibility scores.

3. The system of claim 2 wherein inventory of media channels is estimated based on data from said Sellers.

4. The system of claim 1 wherein the system collects all the available units of estimated inventory and progressively pares down the inventory not qualified for the advertisers under consideration based on costs per CPM.

5. The system of claim 3 wherein compatibility score is based on how well an inventory matches advertiser demand.

6. A commerce management system comprising:
a network-based processor programmed to receive a request for a media campaign from an advertiser;
a network-based interface portal programmed to distribute information regarding past performance and/or expected future performance of a media channel to advertisers; and
a programmed processor implementing an allocation algorithm based on an inventory of media channels and the performance of one or more media channels for a selected promotion.

7. The commerce management system of claim 6 wherein said programmed processor is separate from said network-based processor.

8. The commerce management system wherein said network-based interface is a server supported web portal.

9. The commerce management system of claim 8 wherein said programmed processor applies a compatibility score in said allocation algorithm.

10. The commerce management system of claim 6 wherein said programmed processor is linked to a database storing data on media channel inventory.

11. The commerce management system of claim 11 wherein said programmed processor matches media channel inventory to a campaign in accordance with said allocation algorithm.

12. A computer system comprising:
a market data collection interface programmed to provide user input commands for entry of select data associated with a promotional campaign;
a computer platform that includes a programmed processor for assessing data associated with said campaign and determining an optimized media channel commitment for use in implementing said campaign; and
a transaction support engine for bringing media channel sellers into communication with market campaign developers to implement and track campaign transactions.

13. The computer system of claim 12 further comprising a second programmed controlled interface for supporting interactive entry of media channel data by a seller.

14. The system of claim 13 wherein said second interface is a web portal operable to collect data regarding a promotion campaign.

15. The system of claim 14 wherein said campaign data includes CPM range and/or limits.

16. The system of claim 15 wherein said transaction support engine matches media channel inventory with one of said campaign pursuant to an allocation algorithm.

17. The system of claim 16 wherein said allocation algorithm is implemented using a compatibility score for said inventory.
